(19) United States
(12) Patent Application Publication
(10) Pub. No.: US 2012/0052877 A1
(43) Pub. Date: Mar. 1, 2012

(54) RADIO RECEIVER, RADIO RECEIVING METHOD AND PROGRAM

(75) Inventors: Shinya TANAKA, Tokyo (JP); Tetsuya OKAMOTO, Tokyo (JP); Katsuya TAKAHASHI, Kitagunma-gun (JP)

(73) Assignee: J&K CAR ELECTRONICS CORPORATION, Tokyo (JP)

(21) Appl. No.: 13/218,955

(22) Filed: Aug. 26, 2011

(30) Foreign Application Priority Data
Aug. 27, 2010 (JP) P2010-191358

(51) Int. Cl. H04W 64/00

(52) U.S. Cl. 455/456.1

(57) ABSTRACT

A radio receiver includes a position detecting unit, a broadcasting tower extracting portion, a reception determining portion and an information notifying portion. The position detecting unit detects a plane position of the radio receiver. The broadcasting tower extracting portion calculates a relative distance between the radio receiver and each of broadcasting towers which exist within a relative region, based on the plane position of the radio receiver and plan positions of the broadcasting towers indicated by plural pieces of position information on broadcasting towers, and extracts the predetermined number of broadcasting towers or less in order of increasing relative distance. The reception determining portion determines whether or not the radio receiver can receive a radio broadcast signal from each extracted broadcasting tower. If a radio broadcast signal is received, the information notifying portion notifies a user of information included in the received radio broadcast signal.

### CROSS REFERENCE TO RELATED APPLICATION

This application claims benefit of priority under 35 U.S.C. §119 to Japanese Patent Application No. 2010-191358, filed on Aug. 27, 2010, the entire contents of which are incorporated by reference herein.

### BACKGROUND OF THE INVENTION

1. Field of the Invention

The present invention relates to a radio receiver, a radio receiving method and a program capable of receiving a radio broadcast signal provided by a broadcasting station while switching a broadcasting tower belonging to the broadcasting station.

2. Description of the Related Art

In a terrestrial radio broadcast, the radio field intensity of radio broadcast signal varies according to the positional relation (e.g., relative distance or existence or non-existence of obstacle) between each of broadcasting towers which belong to a broadcasting station transmitting the radio broadcast signal and a radio receiver which receives the radio broadcast signal. Under this circumstance, each of the broadcasting towers is arranged at a position which differs from positions of the other broadcasting towers, and the radio receiver selects a broadcasting tower (frequency of carrier wave for carrying a radio broadcast signal from the broadcasting station) via which the radio receiver will fully receive the radio broadcast signal. Therefore, the radio receiver carries out a channel scan (selection and tuning for a frequency of carrier wave) to select a broadcasting tower via which the radio receiver will fully receive a radio broadcast signal, according to a receiving position of the radio receiver and change in a receiving situation of the radio receiver. Thereby, the radio receiver detects a broadcasting tower which provides a service desired by a user.

However, since the channel scan sequentially detects all broadcasting towers each of which transmits a radio broadcast signal, it takes a lot of time to carry out the channel scan. If the channel scan is frequently carried out, a tuning circuit (tuner) devotes a lot of time to the channel scan, which frequency breaks the flow of radio broadcast signal and increases processing load and power consumption.

In order to solve the above problem, a patent document (Japanese Published Unexamined Patent Application No. 2008-072503) discloses a method for previously storing information on a channel selected by a channel scan and providing the information to a user as a channel list before carrying out a next channel scan.

However, the method disclosed in the patent document 1 requires a scan for all channels when the channel scan is firstly carried out, and always monitors the radio field intensity of radio broadcast signal regarding a channel having been selected. Therefore, the method can not solve negative effects due to a channel scan which is frequently carried out using a real receiving radio wave.

There is another method for detecting a receiving position of radio receiver using a GPS (Global Positioning System) satellite, identifying an area (e.g., country or state) including the receiving position using map data, obtaining a list of all broadcasting towers arranged in the identified area, and carrying out a scan with respect to only the broadcasting towers on the list.

However, the method requires map data previously stored to obtain the list of broadcasting towers. Also, there is a possibility that the method carries out a useless scan if the obtained list includes a broadcasting tower arranged at a large distance from the radio receiver where the radio receiver can not receive a radio broadcast signal via the broadcasting tower, according to a manner of area segmentation. Further, even in a case where a broadcasting tower is arranged at a short distance from the radio receiver where the radio receiver can receive a radio broadcast signal via the broadcasting tower, the method can not extract the broadcasting tower if the broadcasting tower is arranged in an adjacent area and is not included in the obtained list.

### SUMMARY OF THE INVENTION

The present invention has an object to provide a radio receiver, a radio receiving method and program capable of efficiently extracting a broadcasting tower via which a desired radio broadcast signal can be fully received even if map data is not previously stored.

In order to solve the above-described conventional technical problem, the present invention provides a radio receiver comprising: a memory that stores plural pieces of position information on broadcasting towers which indicate plane positions of the broadcasting towers belonging to the same broadcasting station; a receiving unit that receives a radio broadcast signal; a position detecting unit that detects a plane position of the radio receiver; a broadcasting tower extracting portion that calculates a relative distance between the radio receiver and each of one or more broadcasting towers, which belong to the same broadcasting station from which the radio receiver currently receives a radio broadcast signal and exist within a relative region previously defined with reference to the plane position of the radio receiver, based on the plane position of the radio receiver and one or more plan positions of the one or more broadcasting towers indicated by the plural pieces of position information on broadcasting towers, and extracts the predetermined number of broadcasting towers or less in order of increasing relative distance from the smallest relative distance; a reception determining portion that determines whether or not the radio receiver can receive a radio broadcast signal from each of the extracted broadcasting towers; and an information notifying portion that if the reception determining portion determines that the radio receiver can receive a radio broadcast signal, notifies a user of information included in the received radio broadcast signal.

In a preferred embodiment of the present invention, each broadcasting tower is a broadcasting tower capable of providing traffic information or incapable of providing traffic information, information as to whether or not each broadcasting tower can provide traffic information is associated with a piece of position information on each broadcasting tower, and the broadcasting tower extracting portion extracts only one or more broadcasting towers capable of providing traffic information.

In a preferred embodiment of the present invention, each broadcasting tower is a broadcasting tower capable of providing a radio broadcast signal with digital mode or incapable of providing a radio broadcast signal with digital mode, information as to whether or not each broadcasting tower can provide a radio broadcast signal with digital mode is associated with a piece of position information on each broadcasting tower, and the broadcasting tower extracting portion extracts only one or more broadcasting towers capable of providing a radio broadcast signal with digital mode.

In a preferred embodiment of the present invention, the memory stores an identifier for identifying a broadcasting tower from which the radio receiver currently receives a radio broadcast signal, and the reception determining portion preferentially determines whether or not the radio receiver can receive a radio broadcast signal from the broadcasting tower with reference to the identifier.

In order to solve the above-described conventional technical problem, the present invention provides a radio receiving method for receiving a radio broadcast signal using a radio receiver, comprising: storing in a memory plural pieces of position information on broadcasting towers which indicate plane positions of the broadcasting towers belonging to the same broadcasting station; receiving a radio broadcast signal; detecting a plane position of the radio receiver; calculating a relative distance between the radio receiver and each of one or more broadcasting towers, which belong to the same broadcasting station from which the radio receiver currently receives a radio broadcast signal and exist within a relative region previously defined with reference to the plane position of the radio receiver, based on the plane position of the radio receiver and one or more plan positions of the one or more broadcasting towers indicated by the plural pieces of position information on broadcasting towers, extracting the predetermined number of broadcasting towers or less in order of increasing relative distance from the smallest relative distance; determining whether or not the radio receiver can receive a radio broadcast signal from each of the extracted broadcasting towers; and notifying, if the radio receiver can receive a radio broadcast signal, notifies a user of information included in the received radio broadcast signal.

In order to solve the above-described conventional technical problem, the present invention provides a program that causes a computer mounted in a radio receive to function as a position detecting portion that detects a plane position of the radio receiver; a broadcasting tower extracting portion that calculates a relative distance between the radio receiver and each of one or more broadcasting towers, which belong to the same broadcasting station from which the radio receiver currently receives a radio broadcast signal and exist within a relative region previously defined with reference to the plane position of the radio receiver, based on the plane position of the radio receiver and one or more plan positions of the one or more broadcasting towers, and extracts the predetermined number of broadcasting towers or less in order of increasing relative distance from the smallest relative distance; a reception determining portion that determines whether or not the radio receiver can receive a radio broadcast signal from each of the extracted broadcasting towers; and an information notifying portion that if the reception determining portion determines that the radio receiver can receive a radio broadcast signal, notifies a user of information included in the received radio broadcast signal.

Explanations and elements based on technical idea of the above-described radio receiver may have applicability to the radio receiving method and program.

According to the present invention, a broadcasting tower via which a desired radio broadcast signal can be fully received is efficiently extracted even if map data is not previously stored.

### BRIEF DESCRIPTION OF THE DRAWINGS

FIG. 1 is an illustrative diagram that illustrates a schematic connection relation in a radio receiving system according to an exemplary embodiment of the present invention.

FIG. 2 is a functional block diagram that illustrates a schematic configuration of a radio receiver according to the exemplary embodiment of the present invention.

FIG. 3A is an illustrative diagram that illustrates plural pieces of position information on broadcasting towers according to the exemplary embodiment of the present invention.

FIG. 3B is an illustrative diagram that illustrates the plural pieces of position information on broadcasting towers according to the exemplary embodiment of the present invention.

FIG. 4 is an illustrative diagram that illustrates a working of a broadcasting tower extracting portion according to the exemplary embodiment of the present invention.

FIG. 5A is an illustrative diagram that illustrates the working of the broadcasting tower extracting portion according to the exemplary embodiment of the present invention.

FIG. 5B is an illustrative diagram that illustrates the working of the broadcasting tower extracting portion according to the exemplary embodiment of the present invention.

FIG. 6A is an illustrative diagram that illustrates an effect of the radio receiver according to the exemplary embodiment of the present invention.

FIG. 6B is an illustrative diagram that illustrates the effect of the radio receiver according to the exemplary embodiment of the present invention.

FIG. 7 is a flowchart that illustrates a processing flow of a radio receiving method according to the exemplary embodiment of the present invention.

### DESCRIPTION OF THE EMBODIMENTS

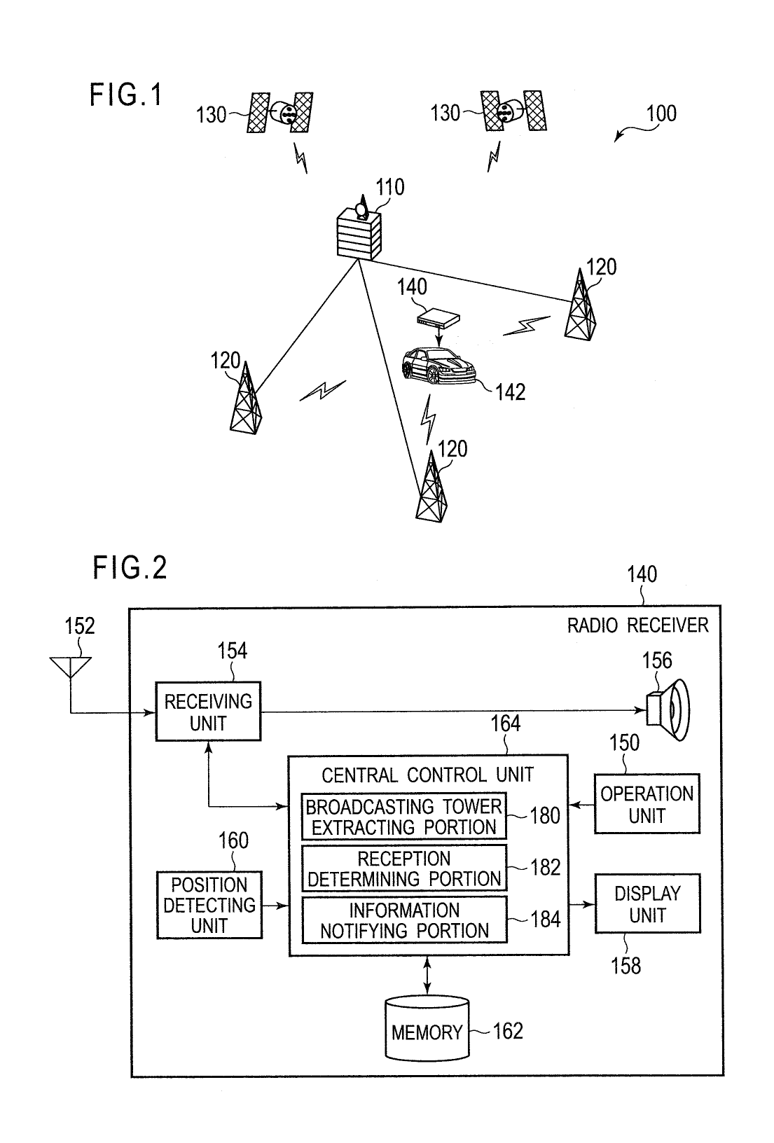

An exemplary embodiment of the present invention will be described in detail below, with reference to FIGS. 1 to 7. Dimensions, materials, concrete numerical values and the like in the present embodiment are cited as one example to facilitate understanding of the present invention, and thus the present invention is not limited to them except as expressly limited in the exemplary embodiment. It is noted that the same symbol is assigned to elements having substantially the same function and configuration in the specification and drawings to avoid repetition in the description. Elements which are not associated directly with the present invention are omitted in the drawings.

As a terrestrial radio broadcast, a hybrid-type radio broadcast or the like is employed according to the change from an analog mode to a digital mode. The hybrid-type radio broadcast provides an analog broadcast and a digital broadcast at the same time using a frequency range of the conventional analog broadcast. For example, HD Radio with IBOC (In-Band-On-Channel) type in practical use in the United State transmits an analog broadcast and a digital broadcast in parallel and provides a service that includes traffic information (HD Traffic) independent of an audio signal. The traffic information includes weather information in a present location and the like. Since the traffic information is provided from only some broadcasting stations, a user needs to detect a broadcasting tower, which belongs to a broadcasting station (FM station), via which he/she can receive the traffic information using a radio receiver from among broadcasting towers. More precisely, a user needs to detect a frequency of carrier wave for carrying a radio broadcast signal provided from a broadcasting tower via which he/she can receive the traffic information using the radio receiver. For convenience, in the present embodiment, the word “broadcasting tower” means not only a real broadcasting tower but also a frequency of carrier wave for carrying a radio broadcast signal provided from the broadcasting tower.

In the terrestrial radio broadcast, there is a case where the necessary radio field intensity can not be secured according to a position of radio receiver. In view of the above, under a situation where plural broadcasting towers belonging to the same broadcasting station each of which transmits a radio broadcast signal are arranged, and a radio receiver carries out a channel scan (selection and tuning for a frequency of carrier wave) for detecting a broadcasting tower from which the radio receiver can fully receive a radio broadcast signal, from among the plural broadcasting towers. However, since the channel scan sequentially detects all broadcasting towers each of which transmits a radio broadcast signal, it takes a lot of time to carry out the channel scan.

There has been a method for detecting a receiving position of radio receiver using a GPS satellite, identifying an area (e.g., country or state) including the receiving position using map data, obtaining a list of all broadcasting towers arranged in the identified area, and carrying out a scan with respect to only the broadcasting towers on the list. The method however requires map data previously stored to obtain the list of broadcasting towers. Also, there is a possibility that the method carries out a useless scan or does not select a proper broadcasting tower according to a manner of area segmentation.

RDS (Radio Data System) is put to practical use in Europe. RDS superimposes AF List (Alternative Frequency List) of broadcasting station on a radio broadcast signal and causes a radio receiver, which is mounted to a moving vehicle such as an automobile, to use AF List. AF List is a list of all frequencies of radio broadcast signals, which include substantially the same contents, are provided by the same broadcasting station, and are to be received by a radio receiver, within an area where the radio receiver is currently located. If the radio field intensity, multipath or noise of a frequency which a radio receiver currently receives reaches a predetermined threshold, the radio receiver carries out a scan with respect to only frequencies on AF List to select a frequency (broadcasting tower) with high reception sensitivity. Thus, the radio receiver can continually receive a radio broadcast signal from the same broadcasting station without interruption.

However, AF List includes only frequencies to be received by a radio receiver within an area where the radio receiver is currently located. Once the radio receiver goes outside the area, AF List to which the radio receiver refers until now becomes to be invalid. This causes the radio receiver to select a broadcasting station which provides a desired radio broadcast signal from among all broadcasting stations. Therefore, the radio receiver consumes a lot of time and electric power by a scan using a real receiving radio wave.

In view of the above, in the present embodiment, even in a case where a public network such as RDS is not configured (AF List is not provided) and map date is not required, a radio receiver efficiently extracts a broadcasting tower via which the radio receiver will fully receive a radio broadcast signal. We will describe a radio receiving system for solving the technical problem and then respective functional units constituting a radio receive in details.

### (Radio Receiving System 100)

FIG. 1 is an illustrative diagram that illustrates a schematic connection relation in a radio receiving system 100. The radio receiving system 100 includes a broadcasting station 110, broadcasting towers 120, GPS satellites 130 and a radio receiver 140.

The broadcasting station 110 provides a terrestrial radio broadcast such as a hybrid-type radio broadcast using an analog mode and a digital mode at the same time. The broadcasting station 110 can superimpose a data signal on an audio signal in a radio broadcast signal. For example, traffic information as data signal is superimposed in the radio broadcast signal in digital mode, as will be described later. Each of the broadcasting towers 120 belongs to the same broadcasting station 110, is arranged at a position which differs from positions of the other broadcasting towers 120, and transmits a radio broadcast signal which the broadcasting station 110 provides.

Each of the GPS satellites 130 is provided with an atomic clock which is a clock employed to measure a time using a spectrum line of atomic or molecule, and transmits a transmitting time indicated by the atomic clock and a GPS signal indicating an orbit (position) thereof using 1.2 or 1.5 GHz wavebands. The radio receiver 140 receives a radio broadcast signal through a radio wave from any one of the broadcasting towers 120. In the present embodiment, the radio receiver 140 is mounted to a moving vehicle 142 such as an automobile and provides a received radio broadcast signal to a passenger in the moving vehicle 142. The radio receiver 140 receives a GPS signal which each of the GPS satellite 130 transmits.

### (Radio Receiver 140)

FIG. 2 is a functional block diagram that illustrates a schematic configuration of the radio receiver 140. The radio receiver 140 includes an operation unit 150, an antenna 152, a receiving unit (tuner) 154, a sound output unit 156, a display unit 158, a position detecting unit 160, a memory 162 and a central control unit 164. The radio receiver 140 is applied to a car navigation system or the like. Since it is not necessary to previously store map data as described above, the radio receiver 140 may be applied to an electronic device in which a GPS receiver is incorporated such as a personal computer, a laptop personal computer, a PDA (Personal Digital Assistant) or a mobile phone.

The operation unit 150 is composed of a switch such as an operation key, an arrow key, a joystick, a jog dial or a touch panel and receives an operation input from a user. The antenna 152 receives a radio wave associated with a terrestrial radio broadcast. The received radio wave is converted into a processable signal in the receiving unit 154.

The receiving unit 154 extracts an FM modulated signal in a carrier wave (carrier) from the processable signal according to an instruction from the central control unit 164 and demodulates it. Then, the receiving unit 154 transmits a demodulated audio signal to the sound output unit 156 and transmits a demodulated data signal to the central control unit 164.

The sound output unit 156 is composed of a speaker or the like and converts into a sound the audio signal transmitted from the receiving unit 154 according to a control instruction from the central control unit 164. The display unit 158 is composed of a liquid crystal display, an organic EL (Electro Luminescence), an LED (Light Emitting Diode) display or the like. The display unit 158 displays contents of the data signal included in the radio broadcast signal according to a control instruction from the central control unit 164.

The position detecting unit 160 demodulates GPS signals transmitted by three or more GPS satellites 130 being tracked thereby, and obtains positions of the three or more GPS satellites 130 and times (transmitting times) when the three or more GPS satellites 130 transmit the GPS signals. Then, the position detecting unit 160 extracts times (receiving times) when the GPS signals are received based on own clock, and calculates each relative distance between each GPS satellite 130 and the radio receiver 140 based on the extracted receiving times and the obtained transmitting times. Further, the position detecting unit 160 obtains a plane position (latitude and longitude information) of the radio receiver 140, which is separated from each GPS satellite 130 by each relative distance calculated based on the positions of the three or more GPS satellites 130, according to a position determination using three-points.

Although the position detecting unit 160 obtains the plane position of the radio receiver 140 using the GPS signals, a method for obtaining the plane position is not limited to it and various conventional methods for obtaining a plane position may be used. For example, the position detecting unit 160 may calculate a distance between the radio receiver 140 and each of at least three broadcasting towers 120 of which plane positions are fixed, and obtain a plane position of the radio receiver 140 according to a position determination using three-points. Also, the position detecting unit 160 may calculate a value of integral in a triaxial accelerometer using the triaxial accelerometer and a compass mounted to the radio receiver 140, and internally obtain a plane position of the radio receiver 140 according to the value of integral. The position detecting unit 160 may be mounted in the central control unit 164. In this case, the position detecting unit 160 is used as a part (position detecting portion) of program which the central control unit 164 executes, as well as a broadcasting tower extracting portion 180, a reception determining portion 182 and an information notifying portion 184 which will be described below.

The memory 162 is composed of a RAM (Random Access Memory), a flash memory, an HDD (Hard Disk Drive) and the like, and stores therein plural pieces of position information on broadcasting towers and various pieces of information necessary to carry out processing in respective functional portions of the central control unit 164. The plural pieces of position information on broadcasting towers are related to the broadcasting towers 120 belonging to the same broadcasting station 110, and represent plane positions of the broadcasting towers 120 each of which transmits a radio broadcast signal provided by the broadcasting station 110.

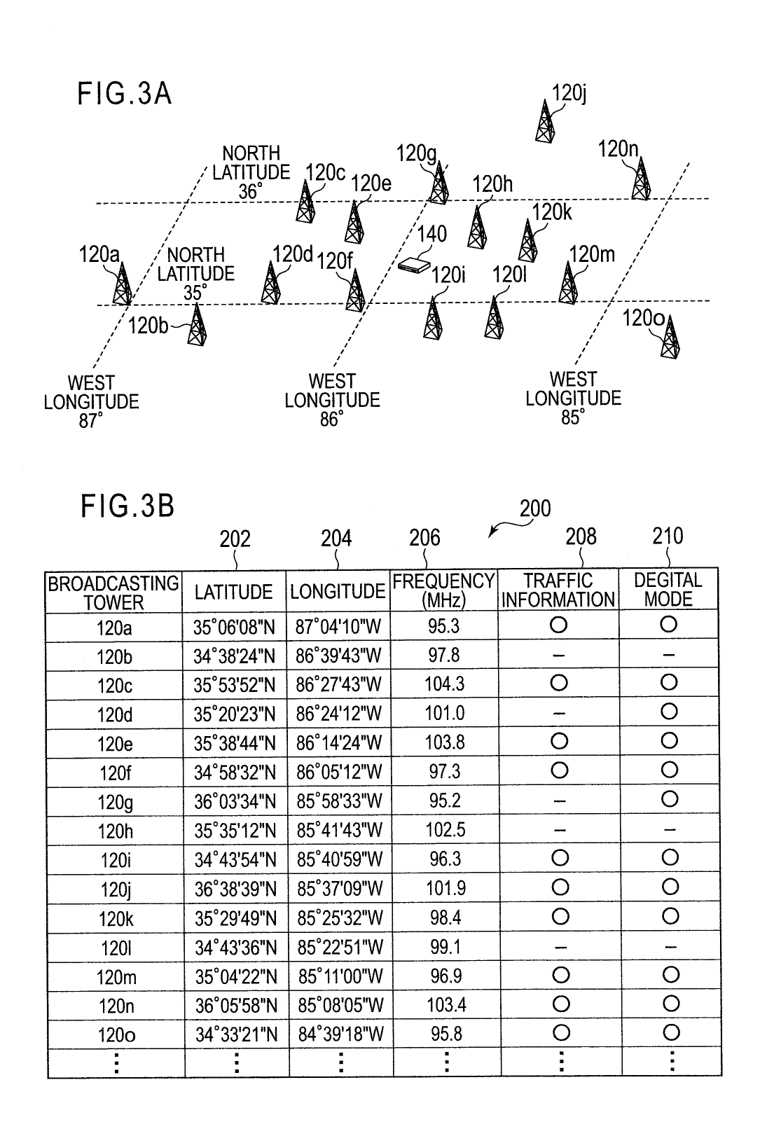

FIGS. 3A and 3B are illustrative diagrams that illustrate plural pieces of position information 200 on broadcasting towers. Especially, FIG. 3A shows one example of plane arrangement of the broadcasting towers 120, and FIG. 3B shows the plural pieces of position information 200 on broadcasting towers. The plural pieces of position information 200 on broadcasting towers shown in FIG. 3B are related to the broadcasting towers 120 belonging to the same broadcasting station 110 included in an area unit such as a country, a prefecture, a city, a state or a group (town). In each piece of position information 200 on broadcasting tower, latitude 202 and longitude 204 indicating a plane position are associated with a frequency 206 of carrier wave. The latitude 202 and the longitude 204 are latitude and longitude on the plane position shown in FIG. 3A. Also, in each piece of position information 200 on broadcasting tower, information as to whether or not traffic information 208 is provided and information as to whether or not a terrestrial radio broadcast uses a digital mode 210 may be associated with them as will be described later. The plural pieces of position information 200 on broadcasting towers are provided by the broadcasting station 110. The plural pieces of position information 200 on broadcasting towers may be previously included in the radio receiver 140 with shipment, be superimposed on a radio broadcast signal, or be downloaded via a communication network such as Internet or a recoding medium.

The central control unit 164 manages and controls the whole of radio receiver 140 by means of a semiconductor integrated circuit including a central processing unit (CPU), a ROM in which programs and the like are stored, a RAM which functions as a work area, and the like. In the present embodiment, the central control unit 164 functions as the broadcasting tower extracting portion 180, the reception determining portion 182 and the information notifying portion 184.

We assume that the radio receiver 140 previously receives a radio broadcast signal transmitted by the broadcasting station 110. The broadcasting tower extracting portion 180 obtains a plane position (latitude and longitude) of the radio receiver 140 from the position detecting unit 160. Then, with reference to plural pieces of position information 200 on broadcasting towers regarding the broadcasting station 110 which transmits the radio broadcast signal, the broadcasting tower extracting portion 180 extracts one or more broadcasting towers 120, which exist within a relative region previously determined based on the obtained plane position of the radio receiver 140, from among one or more broadcasting towers 120 each of which belongs to the broadcasting station 110 and is registered in each piece of position information 200 on broadcasting tower.

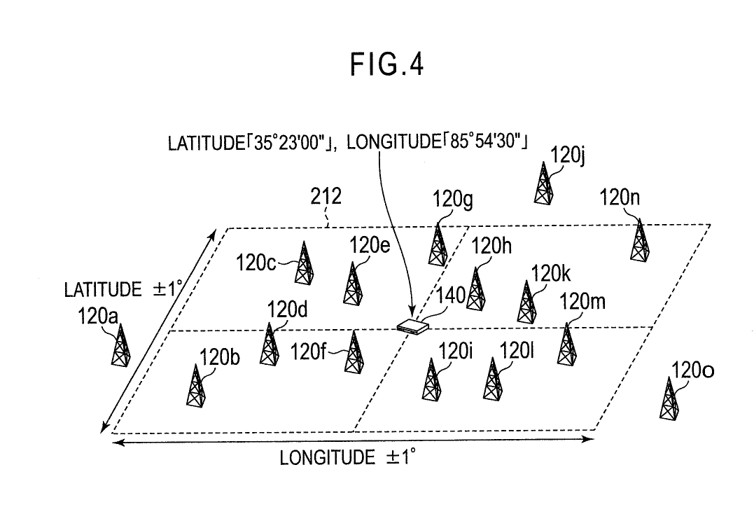

FIG. 4 is an illustrative diagram that illustrates a working of the broadcasting tower extracting portion 180. For example, in a case where the plane position of the radio receiver 140 is identified as latitude (35° 23′ 00″) and longitude (85° 54′ 30″) by the position detecting unit 160, the broadcasting tower extracting portion 180 extracts broadcasting towers 120, which exist within a relative region 212 (relative region between latitudes ±1° with respect to the latitude (35° 23′ 00″) of plane position and between longitudes ±1° with respect to the longitude (85° 54′ 30″) of plane position), based on the plane position of the radio receiver 140. Therefore, as shown in FIG. 4, broadcasting towers 120b, 120c, 120d, 120e, 120f, 120g, 120h, 120i, 120k, 1201, 120m and 120n are extracted and broadcasting towers 120a, 120j and 120o are excluded.

The reason that the number of broadcasting towers 120 is firstly reduced based on the relative region 212 is as follows. For example, all broadcasting towers 120 mounted in a concerned country are registered in plural pieces of position information 200 on broadcasting towers. In order to extract a broadcasting tower 120 which has a small relative distance between the radio receiver 140 and the broadcasting tower 120, the broadcasting tower extracting portion 180 firstly needs to calculate a relative distance between the radio receiver 140 and each of all broadcasting towers 120, which increases processing load. However, even if the broadcasting tower extracting portion 180 calculates a relative distance between the radio receiver 140 and a broadcasting tower 120 via which a radio wave does not reach the radio receiver 140 or via which there is an extremely low probability that a radio wave reach the radio receiver 140, the broadcasting tower 120 is not extracted. In view of the above, in order to calculate a relative distance between the radio receiver 140 and each of broadcasting towers 120 which exist within the relative region 212, the broadcasting tower extracting portion 180 firstly reduces the number of broadcasting towers 120 based on the relative region 212.

The reason that a relative region between latitudes ±1° with respect to the latitude of plane position and between longitudes ±1° with respect to the longitude of plane position is set is as follows. For example, it has been said that the upper limit of a travel distance of radio wave in FM broadcast with digital mode is a value within the range between 90 km and 100 km based on the minimum input sensitivity of radio receiver 140 and the coverage map of broadcasting station 110 of which the radio field intensity is relatively high. If a relative region is set in the ranges between latitudes ±1° with respect to the latitude of plane position and between longitudes ±1° with respect to the longitude of plane position (that is, the ranges between ±111 km in the latitudinal direction with respect to the plane position and between ±91 km in the longitudinal direction with respect to the plane position in the case where the latitude of plane position is 35°), the relative region fully includes the travel distance of radio wave. Therefore, candidates for a broadcasting tower 120 from which the radio receiver 140 receives a radio wave are almost included in the relative region 212 between latitudes ±1° with respect to the latitude of plane position and between longitudes ±1° with respect to the longitude of plane position.

Then, based on the plane position of radio receiver 140 and plane positions of all broadcasting towers 120 which exist within the relative region 212, the broadcasting tower extracting portion 180 calculates a relative distance between the radio receiver 140 and each of the broadcasting towers 120. More specifically, the broadcasting tower extracting portion 180 calculates a difference value “a1” between the latitude of the plane position of radio receiver 140 and latitude 202 of the plane position of each broadcasting tower 120 which is registered in each piece of position information 200 on broadcasting tower, and a difference value “b1” between the longitude of the plane position of radio receiver 140 and longitude 204 of the plane position of the each broadcasting tower 120 which is registered in the each piece of position information 200 on broadcasting tower. The broadcasting tower extracting portion 180 converts the difference values “a1” and “b1” of latitude and longitude into distances “a2” and “b2” using the following equation “about 40000 km×(a1 or b1)/360°” and then calculates a relative distance using the following equation \sqrt{a2²+b2²}. Although the difference values of latitude and longitude are converted into distances, a relative distance may be calculated using angle values of latitude and longitude because the relative distance is used to measure the closeness between the radio receiver 140 and each broadcasting tower 120 in the present embodiment.

When relative distances between the radio receiver 140 and all broadcasting towers 120 are calculated, the broadcasting tower extracting portion 180 extracts the predetermined number of broadcasting towers 120 or less (e.g., ten or less broadcasting towers 120) in order of increasing relative distance from the smallest relative distance.

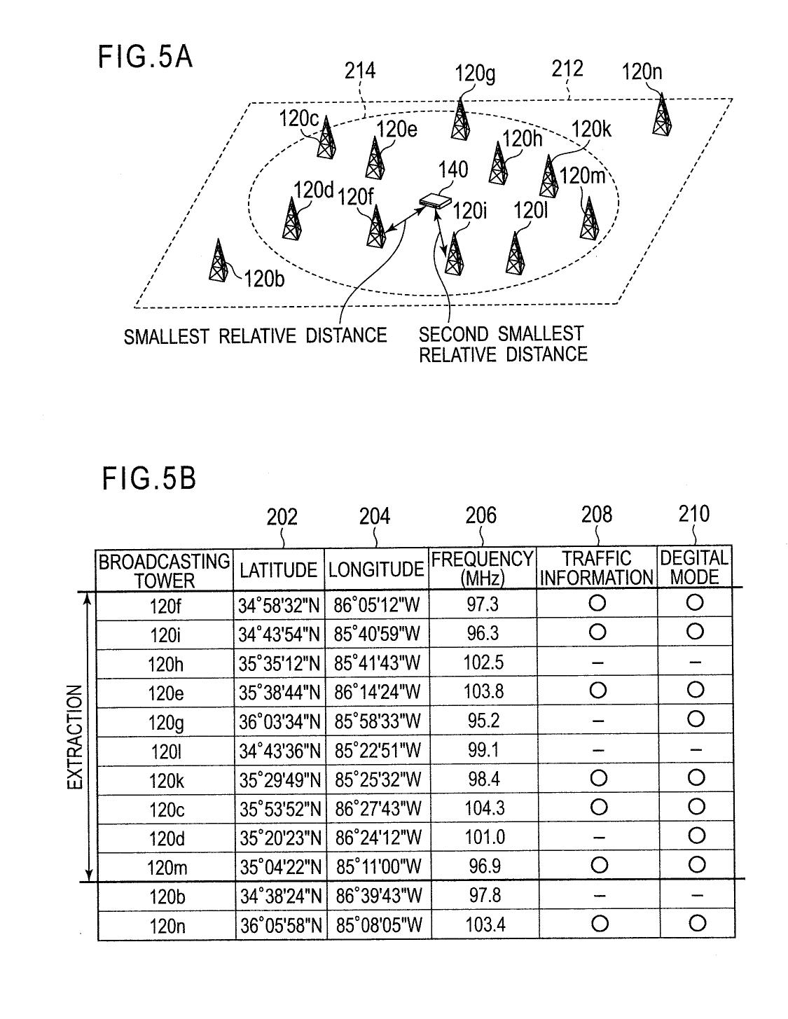

FIGS. 5A and 5B are illustrative diagrams that illustrate the working of the broadcasting tower extracting portion 180.

The broadcasting towers 120b, 120c, 120d, 120e, 120f, 120g, 120h, 120i, 120k, 120l, 120m and 120n which exist within the relative region 212 shown in FIG. 4 are ranked in order of increasing relative distance between the radio receiver 140 and each broadcasting tower 120. For example, relative distances regarding the broadcasting towers 120b, 120c, 120d, 120e, 120f, 120g, 120h, 120i, 120k, 120l, 120m and 120n which exist within the relative region 212 shown in FIG. 5A are calculated, and then ranked in order of increasing relative distance from the smallest relative distance as shown in FIG. 5B. The broadcasting tower extracting portion 180 extracts ten broadcast towers in order of increasing relative distance as shown in FIG. 5B. Thus, the broadcasting towers 120c, 120d, 120e, 120f, 120g, 120h, 120i, 120k, 120l and 120m, which exist within a region 214, are extracted and the broadcasting towers 120b and 120n are excluded.

Although the extracted number of broadcasting towers 120 is set to ten, it is not limited to ten and may be set to an arbitrary value. It is noted that in a case where the extracted number is too small, there is a possibility that there is not any candidate for a broadcasting tower 120 from which the reception determining portion 182 can receive a radio wave. If there is not any candidate for a broadcasting tower 120 from which the reception determining portion 182 can receive a radio wave, the broadcasting tower extracting portion 180 needs to extend the region where broadcasting towers 120 are to be extracted, and then again extract broadcasting towers 120 except for broadcasting towers 120 having been firstly extracted. It is desirable that the extracted number is set to a value in which the extracting processing is not carried out again and processing load is not increased. Therefore, the extracted number may be adequately changed according to the density of broadcasting towers 120 in a concerned area, the receiving sensitivity of radio receiver 140, and a service mode of the radio receiving system 100.

The reason that the extracted number is set to ten or less is as follows. In a case where ten or more broadcasting towers 120 do not exist within a relative region, it is impossible to extract ten broadcasting towers 120. In this case, all broadcasting towers 120 which exist within the relative region 212 are extracted as candidates for a broadcasting tower 120 from which the reception determining portion 182 can receive a radio wave.

The broadcasting tower extracting portion 180 carries out extraction of broadcasting towers 120 at a specific time interval (e.g., once per several minutes). It is noted that even if a relative distance between the radio receiver 140 and a concerned broadcasting tower 120 changes as the moving vehicle 142 moves, the frequency with which (the concerned broadcasting tower 120 from which) the reception determining portion 182 currently receives a radio wave is not immediately changed, and the concerned broadcasting tower 120 from which the reception determining portion 182 currently receives a radio wave keeps being used until the reception determining portion 182 can not receive the radio wave from the broadcasting tower 120.

As described above, in the present embodiment, the broadcasting tower extracting portion 180 calculates a relative distance between the radio receiver 140 and each broadcasting tower 120 as the moving vehicle 142 moves, and then extracts a broadcasting tower 120 from which the radio receiver 140 can fully receive a radio wave. However, the broadcasting tower extracting portion 180 selects a new broadcasting tower 120 whenever calculating relative distances, which makes a process for switching a broadcasting tower 120 from which the radio receiver 140 can fully receive a radio wave cumbersome and complicated. This increases processing load. Therefore, a broadcasting tower 120 from which the reception determining portion 182 currently receives a radio wave keeps being used until the reception determining portion 182 can not receive the radio wave from the broadcasting tower 120.

More specifically, the memory 162 stores an identifier of a broadcasting tower 120 from which the radio receiver 140 currently receives a radio wave. The broadcasting tower extracting portion 180 preferentially extracts the broadcasting tower 120 from which the radio receiver 140 currently receives a radio wave with reference to the identifier, and causes the reception determining portion 182 to preferentially determine whether or not the radio receiver 140 can receive a radio wave from the broadcasting tower 120. If the radio receiver 140 can not receive a radio wave from the broadcasting tower 120, the process for switching a broadcasting tower 120 is carried out. The identifier of broadcasting tower 120 may be managed in the form of a unique number such as a hash value or a frequency of carrier wave for uniquely identifying the broadcasting tower 120.

For example, the reception determining portion 182 determines whether or not the radio receiver 140 can receive a radio wave from a broadcasting tower 120 extracted by the broadcasting tower extracting portion 180, in order of increasing relative distance from the smallest relative distance. More specifically, the reception determining portion 182 determines whether or not the radio field intensity of received radio wave has more than a certain value, or whether or not data included in the received radio wave are correctly obtained (e.g., whether or not traffic information is included in the received radio broadcast signal). In FIG. 5A, the reception determining portion 182 firstly determines whether or not the radio receiver 140 can receive a radio wave from the broadcasting tower 120f having the smallest relative distance. If the radio receiver 140 can not receive the radio wave, the reception determining portion 182 determines whether or not the radio receiver 140 can receive a radio wave from the broadcasting tower 120i having the second smallest relative distance.

There is a case where the radio receiver 140 can not receive a radio broadcast signal correctly because the radio field intensities of radio broadcast signals differ from each other according to each positional relation (e.g., relative distance or existence or non-existence of obstacle) between the radio receiver 140 and each broadcasting tower 120. However, in the present embodiment, since ten broadcasting towers 120 are extracted as candidates for a broadcasting tower 120 from which the radio receiver 140 can fully receive a radio wave, the radio receiver 140 can receive a radio broadcast signal from any extracted broadcasting tower 120. In addition, since the reception determining portion 182 determines whether or not the radio receiver 140 receives a radio wave from a broadcasting tower 120 in order of increasing relative distance from the smallest relative distance (that is, in order of decreasing radio field intensity of radio wave from the largest radio field intensity if a radio wave can be received), the reception determining portion 182 can select a broadcasting tower 120 having a relatively high radio field intensity of radio wave.

When the reception determining portion 182 determines that the radio receiver 140 can receive a radio broadcast signal from a broadcasting tower 120, the information notifying portion 184 notifies a user of information included in the radio broadcast signal from the broadcasting tower 120. In one case where the user wants to know the information in the form of audio signal, he/she sends a control instruction to the sound output unit 156 to cause the information notifying portion 184 to output a sound via the sound output unit 156. In another case where the user wants to know the information in the form of data signal, he/she sends a control instruction to the display unit 158 to cause the information notifying portion 184 to display data generated by demodulating the data signal via the display unit 158.

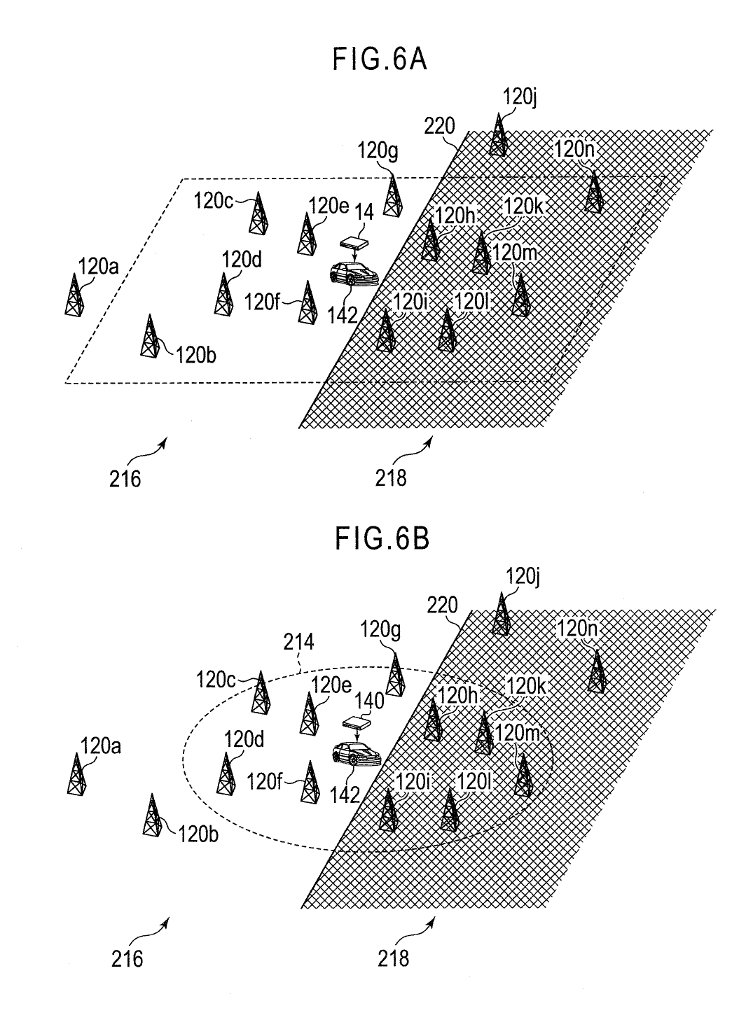

FIGS. 6A and 6B are illustrative diagrams that illustrate an effect of the radio receiver 140. A list of candidates for a broadcasting tower 120 from which the radio receiver 140 can fully receive a radio wave is conventionally managed by a region (e.g., region 216 or 218) where a service is provided. As shown in FIG. 6A, when the moving vehicle 142 approaches a border 220 between the regions 216 and 218 from a midpoint in the region 216, the broadcasting tower extracting portion 180 needs to carry out a scan for the useless broadcasting tower 120a from which the radio receiver 140 can not receive a radio wave because the list regarding the region 216 includes the broadcasting tower 120a. In addition, as shown in FIG. 6A, even if the broadcasting towers 120i and 120h from which the radio receiver 140 can receive a radio wave and which have small relative distances exist in the adjacent region 218, the broadcasting tower extracting portion 180 cannot extract the broadcasting towers 120i and 120h because the list regarding the region 216 does not include the broadcasting towers 120i and 120h. This means that a scan for the useful broadcasting towers 120i and 120h is not carried out.

Further, in order to obtain a list managed by a region using a conventional method, a position where the radio receiver 140 exists is detected using the GPS satellite 130, and then a region including the position is identified using map data. This means that it is necessary to previously store map data in order to obtain a list for candidates for a broadcasting tower 120 from which the radio receiver 140 can fully receive a radio wave.

In the present embodiment, since the broadcasting tower extracting portion 180 extracts broadcasting towers 120 in order of increasing relative distance between the radio receiver 140 and each broadcasting tower 120 from the smallest relative distance, all extracted broadcasting towers 120 are included in the region 214 shown in FIG. 6B where a radio wave is expected to reach the radio receiver 140. Therefore, it is possible to select a broadcasting tower 120 from which the radio receiver 140 can fully receive a radio broadcast signal without being limited by the border 220 between the regions 216 and 218. Also, in the present embodiment, if the radio receiver 140 stores therein only the plural pieces of position information 200 on broadcasting towers of which data amount is less than the amount of map data even in a place where a public network such as RDS is not configured, the radio receiver 140 can efficiently extract a broadcasting tower from which the radio receiver can fully receive a radio broadcast signal.

The broadcasting station 110 provides the same radio broadcast signal to broadcasting towers 120. Transmission capability of broadcasting tower 120 differs from another broadcasting tower 120 according to ages when the broadcasting towers 120 are mounted, equipments of the broadcasting towers 120 and sizes of the broadcasting towers 120. This means that all broadcasting towers 120 do not necessarily correspond to all transmission modes of radio broadcast signal provided by the broadcasting station 110. Therefore, since each broadcasting tower 120 transmits a radio broadcast signal with own transmission modes according to own transmission capability, there is a case where broadcasting towers 120 belonging to the same broadcasting station 110 transmit radio broadcast signals of which contents differ from one another.

For example, the transmission modes include a mode as to whether or not traffic information included in the radio broadcast signal is provided, and a mode as to whether or not the radio broadcast signal corresponds to a digital mode. Namely, there are one broadcasting tower 120 capable of providing traffic information according to own transmission modes and the other broadcasting tower 120 incapable of providing traffic information according to own transmission modes. Also, there are one broadcasting tower 120 capable of providing a radio broadcast signal with digital mode and the other broadcasting tower 120 incapable of providing a radio broadcast signal with digital mode. In the present embodiment, even if the moving vehicle 142 to which the radio receiver 140 is mounted moves, the radio receiver 140 can continually receive the same radio broadcast signal provided by the broadcasting station 110. However, there is a case where under a situation where the radio receiver 140 switches from one broadcasting tower 120 to another broadcasting tower 120 wherein they belong to the same broadcasting station 110, the another broadcasting tower 120 does not adopt transmission modes of the one broadcasting tower 120.

Under a situation where the radio receiver 140 receives radio broadcast signal including traffic information, there is a possibility that the radio receiver 140 selects a next broadcasting tower 120 from which a radio broadcast signal not including traffic information is transmitted while the next broadcasting tower 120 has high radio field intensity in the above-described embodiment. In this case, since the radio receiver 140 needs to search a broadcasting tower 120 from which (frequency with which) a radio broadcast signal including traffic information is transmitted by itself, it takes a lot of time to select the broadcasting tower 120 from which a radio broadcast signal including traffic information is transmitted. Also, in a case where a radio broadcast signal including traffic information is transmitted with digital mode, it takes about one second to select a broadcasting tower 120 from which a radio broadcast signal is transmitted with digital mode, and then it takes a lot of time more than one second to determine whether or not the selected broadcasting tower transmits a radio broadcast signal including traffic information.

Thus, if it takes a lot of time to determine whether or not the selected broadcasting tower 120 adopts desired transmission modes, obtainment of necessary traffic information is delayed. This further delays response of another device when the another device works with the traffic information. The present embodiment addresses the above-described problem as follows.

In a case where the transmission modes of broadcasting station 110 includes a mode as to whether or not traffic information is included in a radio broadcast signal, each piece of information as to whether or not a broadcasting tower 120 is capable of providing traffic information is associated with each piece of position information 200 on broadcasting tower, as shown in FIG. 3B. The broadcasting tower extracting portion 180 extracts the predetermined number of broadcasting towers 120 capable of providing traffic information, in order of increasing relative distance from the smallest relative distance.

For example, in a case where the radio receiver 140 can obtain a radio broadcast signal which includes traffic information provided by the broadcasting station 110 at the time when a user selects a channel for the first time, the broadcasting tower extracting portion 180 understands that traffic information is obtained by the radio receiver 140. After this time, the broadcasting tower extracting portion 180 extracts only broadcasting towers 120 capable of providing traffic information (e.g., the broadcasting towers 120c, 120e, 120f, 120i, 120k, 120m and 120n shown in FIG. 5B) until the broadcasting station 110 is switched to another broadcasting station 110. Then, the reception determining portion 182 determines whether or not the radio receiver 140 can receive a radio broadcast signal from a broadcasting tower 120 capable of providing traffic information in order of increasing relative distance from the smallest relative distance.

This configuration previously excludes a broadcasting tower 120 incapable of providing traffic information, which promptly and surely provides traffic information without requiring great care and time.

Also, in a case where the transmission modes of broadcasting station 110 includes a mode as to whether or not a radio broadcast signal corresponds to the digital mode, each piece of information as to whether or not a broadcasting tower 120 corresponds to the digital mode is associated with each piece of position information 200 on broadcasting tower as shown in FIG. 3B, as well as traffic information. The broadcasting tower extracting portion 180 extracts the predetermined number of broadcasting towers 120 corresponding to the digital mode, in order of increasing relative distance from the smallest relative distance. Since a data transfer speed in digital mode is higher than one in analog mode, a data update rate and a data transfer total amount are increased. Also, since a noise in digital mode is lower than one in analog mode in general, data can be surely transferred. Even in a case where an audio signal is transmitted in digital mode instead of a data signal, sound quality is increased.

For example, in a case where the radio receiver 140 can obtain a radio broadcast signal in digital mode provided by the broadcasting station 110 at the time when a user selects a channel for the first time, the broadcasting tower extracting portion 180 understands that the radio broadcast signal in digital mode is obtained by the radio receiver 140. After this time, the broadcasting tower extracting portion 180 extracts only broadcasting towers 120 corresponding to the digital mode (e.g., the broadcasting towers 120c, 120d, 120e, 120f, 120g, 120i, 120k, 120m and 120n shown in FIG. 5B) until the broadcasting station 110 is switched to another broadcasting station 110. Then, the reception determining portion 182 determines whether or not the radio receiver 140 can receive a radio broadcast signal from a broadcasting tower 120 corresponding to the digital mode in order of increasing relative distance from the smallest relative distance.

As well as traffic information, this configuration previously excludes a broadcasting tower 120 not corresponding to the digital mode, which allows a broadcasting tower 120 from which the radio receiver 140 can fully receive a radio broadcast signal in digital mode to be efficiently extracted without requiring great care and time.

As described above, the radio receiver 140 does not need map data. Even in a place where a public network such as RDS is not configured, the radio receiver 140 does not need to carry out a scan for all real frequencies. If the radio receiver 140 stores therein plural pieces of position information 200 on broadcasting towers which indicate the plane positions of broadcasting towers 120, reduces the number of candidates for a broadcasting tower 120 from which the radio receiver 140 can receive a radio broadcast signal to the predetermined number, and determines whether or not the radio receiver 140 can fully receive a radio broadcast signal from each of the candidates in order of increasing relative distance from the smallest relative distance which is expected to represent high radio filed intensity, the radio receiver 140 can efficiently (promptly and surely) extract a broadcasting tower 120 from which the radio receiver 140 can fully receive a radio broadcast signal.

Further, by making plural pieces of position information 200 on broadcasting towers by an area unit such as country or state, even if the radio receiver 140 strides adjacent areas such as prefecture or group (town), the radio receiver 140 can receive a radio broadcast signal from a broadcasting tower 120 which has the small relative distance between the radio receiver 140 and the broadcasting tower 120. Therefore, the radio receiver 140 can continually receive a desired radio broadcast signal without restrictions by areas such as prefecture or group.

A program that causes a computer mounted in the radio receive 140 to function as the following portions may be provided in the present embodiment: a position detecting portion that detects a plane position of the radio receiver 140; a broadcasting tower extracting portion that calculates a relative distance between the radio receiver 140 and each of one or more broadcasting towers 120, which belong to the same broadcasting station 110 from which the radio receiver 140 currently receives a radio broadcast signal and exist within a relative region previously defined with reference to the plane position of the radio receiver 140, based on the plane position of the radio receiver 140 and one or more plan positions of the one or more broadcasting towers 120, and extracts the predetermined number of broadcasting towers 120 or less in order of increasing relative distance from the smallest relative distance; a reception determining portion that determines whether or not the radio receiver 140 can receive a radio broadcast signal from each of the extracted broadcasting towers 120; and an information notifying portion that if the reception determining portion determines that the radio receiver 140 can receive a radio broadcast signal, notifies a user of information included in the received radiobroadcast signal. Also, a storage medium such as a flexible disk, magnet-optical disk, ROM, EPROM, EEPROM, CD (Compact Disc), DVD or BD which stores the program and is readable by a computer, may be provided in the present embodiment. The program is data processing means described by an arbitrary language or description method.

### (Radio Receiving Method)

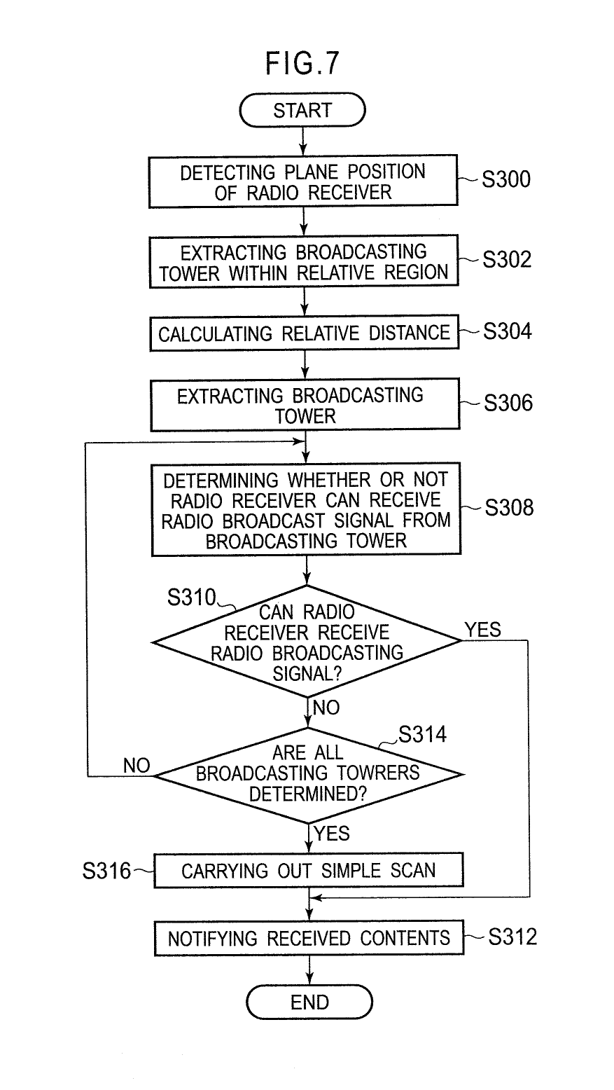

FIG. 7 is a flowchart that illustrates a processing flow of a radio receiving method. In the radio receiver 140, the memory 162 previously stores plural pieces of position information 200 on broadcasting towers therein. A user receives a radio broadcast signal from the broadcasting station 110 using the radio receiver 140.

In step S300, the position detecting unit 160 of the radio receiver 140 detects a plane position of the radio receiver 140 using the GPS satellites 130. In step S302, the broadcasting tower extracting portion 180 extracts one or more broadcasting towers 120 which belong to the same broadcasting station 110 from which the radio receiver 140 currently receives a radio broadcast signal and exist within a relative region 212 previously defined based on the plane position of the radio receiver 140. In step S304, the broadcasting tower extracting portion 180 calculates a relative distance between the radio receiver 140 and each extracted broadcasting tower 120 based on the plan position of the radio receiver 140 and a plane position of each extracted broadcasting tower 120. In step S306, the broadcasting tower extracting portion 180 extracts the predetermined number of broadcasting towers 120 or less (e.g., ten or less broadcasting towers 120) in order of increasing relative distance from the smallest relative distance.

In step S308, the reception determining portion 182 picks up a broadcasting tower 120 in order of increasing relative distance from the smallest relative distance with respect to the broadcasting towers 120 extracted by the broadcasting tower extracting portion 180, and determines whether or not the radio receiver 140 can receive a radio broadcast signal from the broadcasting tower 120. If the radio receiver 140 can receive the radio broadcast signal (YES), the processing proceeds to step S312. In step S312, the information notifying portion 184 notifies the user of information included in the radio broadcast signal from the broadcasting tower 120 picked up in step S308. If the radio receiver 140 can not receive the radio broadcast signal (NO), the processing proceeds to step S314. In step S314, the reception determining portion 182 determines whether or not all broadcasting towers 120 extracted by the broadcasting tower extracting portion 180 are determined in step S308. If all broadcasting towers 120 are not determined (NO), the proceeding returns to step S308 and then the reception determining portion 182 picks up a broadcasting tower 120 having the next smallest relative distance.

If all broadcasting towers 120 are determined (YES), the proceeding to step S316. In step S316, a conventional simple scan is carried out with respect to all frequencies to detect a desired broadcasting station 110. In step S312, the information notifying portion 184 notifies the user of information included in a radio broadcast signal from a detected broadcasting tower 120. Thereby, a user can receive a desired radio broadcast signal.

The radio receiving method allows the radio receiver 140 to efficiently extract a broadcasting tower 120 from which the radio receiver 140 can fully receive a radio broadcast signal without requiring map data.

Although the exemplary embodiment of the present invention is described with reference to FIGS. 1 to 7, the present invention is not limited to it. It is obvious for a skilled person that various modifications which are made to the present embodiment within the scope of claims belong to the present invention.

Although the present embodiment describes that the radio receiver 140 directly displays on the display unit 158 traffic information included in a radio broadcast signal which the radio receiver 140 receives, the method for displaying traffic information is not limited to it. The radio receiver 140 may cooperate with devices in a car navigation system to indirectly display traffic information. For example, the radio receiver 140 provides a user to traffic jam information by coloring in red a route to his/her destination on a display screen in the car navigation system or provides a user to weather information in an area where he/she stays according to the traffic information.

Although the steps of radio receiving method are processed in sequence according to the flowchart in FIG. 7, they may be processed in parallel or by subroutine.

What is claimed is:

1. A radio receiver comprising:
a memory that stores plural pieces of position information on broadcasting towers which indicate plane positions of the broadcasting towers belonging to the same broadcasting station;
a receiving unit that receives a radio broadcast signal;
a position detecting unit that detects a plane position of the radio receiver;
a broadcasting tower extracting portion that calculates a relative distance between the radio receiver and each of one or more broadcasting towers, which belong to the same broadcasting station from which the radio receiver currently receives a radio broadcast signal and exist within a relative region previously defined with reference to the plane position of the radio receiver, based on the plane position of the radio receiver and one or more plan positions of the one or more broadcasting towers indicated by the plural pieces of position information on broadcasting towers, and extracts the predetermined number of broadcasting towers or less in order of increasing relative distance from the smallest relative distance;
a reception determining portion that determines whether or not the radio receiver can receive a radio broadcast signal from each of the extracted broadcasting towers; and
an information notifying portion that if the reception determining portion determines that the radio receiver can receive a radio broadcast signal, notifies a user of information included in the received radio broadcast signal.

2. The radio receiver according to claim 1,
wherein each broadcasting tower is a broadcasting tower capable of providing traffic information or incapable of providing traffic information,
information as to whether or not each broadcasting tower can provide traffic information is associated with a piece of position information on each broadcasting tower, and
the broadcasting tower extracting portion extracts only one or more broadcasting towers capable of providing traffic information.

3. The radio receiver according to claim 1,
wherein each broadcasting tower is a broadcasting tower capable of providing a radio broadcast signal with digital mode or incapable of providing a radio broadcast signal with digital mode,
information as to whether or not each broadcasting tower can provide a radio broadcast signal with digital mode is associated with a piece of position information on each broadcasting tower, and
the broadcasting tower extracting portion extracts only one or more broadcasting towers capable of providing a radio broadcast signal with digital mode.

4. The radio receiver according to claim 1,
wherein the memory stores an identifier for identifying a broadcasting tower from which the radio receiver currently receives a radio broadcast signal, and
the reception determining portion preferentially determines whether or not the radio receiver can receive a radio broadcast signal from the broadcasting tower with reference to the identifier.

5. A radio receiving method for receiving a radio broadcast signal using a radio receiver, comprising:
storing in a memory plural pieces of position information on broadcasting towers which indicate plane positions of the broadcasting towers belonging to the same broadcasting station;
receiving a radio broadcast signal;
detecting a plane position of the radio receiver;
calculating a relative distance between the radio receiver and each of one or more broadcasting towers, which belong to the same broadcasting station from which the radio receiver currently receives a radio broadcast signal and exist within a relative region previously defined with reference to the plane position of the radio receiver, based on the plane position of the radio receiver and one or more plan positions of the one or more broadcasting towers indicated by the plural pieces of position information on broadcasting towers,
extracting the predetermined number of broadcasting towers or less in order of increasing relative distance from the smallest relative distance;
determining whether or not the radio receiver can receive a radio broadcast signal from each of the extracted broadcasting towers; and
notifying, if the radio receiver can receive a radio broadcast signal, notifies a user of information included in the received radio broadcast signal.

6. A program that causes a computer mounted in a radio receive to function as
a position detecting portion that detects a plane position of the radio receiver;
a broadcasting tower extracting portion that calculates a relative distance between the radio receiver and each of one or more broadcasting towers, which belong to the same broadcasting station from which the radio receiver currently receives a radio broadcast signal and exist within a relative region previously defined with reference to the plane position of the radio receiver, based on the plane position of the radio receiver and one or more plan positions of the one or more broadcasting towers, and extracts the predetermined number of broadcasting towers or less in order of increasing relative distance from the smallest relative distance;
a reception determining portion that determines whether or not the radio receiver can receive a radio broadcast signal from each of the extracted broadcasting towers; and
an information notifying portion that if the reception determining portion determines that the radio receiver can receive a radio broadcast signal, notifies a user of information included in the received radio broadcast signal.
